(19) United States
(12) Patent Application Publication
(10) Pub. No.: US 2013/0044695 A1
(43) Pub. Date: Feb. 21, 2013

(54) Fast link establishment for wireless stations operating in millimeter-wave band

(71) Applicants: Zhemin Xu, Pleasanton, CA (US); Gang Lu, Pleasanton, CA (US)

(72) Inventors: Zhemin Xu, Pleasanton, CA (US); Gang Lu, Pleasanton, CA (US)

(73) Assignee: BROADCOM CORPORATION, Irvine, CA (US)

(21) Appl. No.: 13/211,902

(22) Filed: Aug. 17, 2011

(51) Int. Cl. H04W 76/02

(52) U.S. Cl. 370/329

(57) ABSTRACT

A technique to transmit feedback frames from a control point in each slot of an Association-Beamforming Training Period, as specified in a 60 GHz DBand specification, where at least one sector sweep frame is transmitted from a responding station and at least one sector sweep frame is received by the control point, in order to increase the chance of establishing a directional communication link between the control point and the station.

### BACKGROUND OF THE INVENTION

1. Technical Field of the Invention

The embodiments of the invention relate to wireless communications and, more particularly, to linking of two devices at millimeter-wave bands.

2. Description of Related Art

Various wireless communication systems are known today to provide communication links between devices, whether directly or through a network. Such communication systems range from national and/or international cellular telephone systems, the Internet, point-to-point in-home systems, as well as other systems. Communication systems typically operate in accordance with one or more communication standards or protocols. For instance, wireless communication systems may operate using protocols, such as IEEE 802.11, Bluetooth™, advanced mobile phone services (AMPS), digital AMPS, global system for mobile communications (GSM), code division multiple access (CDMA), local multi-point distribution systems (LMDS), multi-channel-multi-point distribution systems (MMDS), as well as others.

For each wireless communication device to participate in wireless communications, it generally includes a built-in radio transceiver (i.e., receiver and transmitter) or is coupled to an associated radio transceiver (e.g., a station for in-home and/or in-building wireless communication networks, modem, etc.). Typically, the transceiver includes a baseband processing stage and a radio frequency (RF) stage. The baseband processing provides the conversion from data to baseband signals for transmitting and baseband signals to data for receiving, in accordance with a particular wireless communication protocol. The baseband processing stage is coupled to a RF stage (transmitter section and receiver section) that provides the conversion between the baseband signals and RF signals. The RF stage may be a direct conversion transceiver that converts directly between baseband and RF or may include one or more intermediate frequency stage(s).

Furthermore, wireless devices typically operate within certain radio frequency ranges or band established by one or more communication standards or protocols. The 2.4 GHz Band that encompasses current WiFi and Bluetooth™ protocols has limited data throughput. A newer 60 GHz standard pursues higher throughput of up to 7 Gbps in short-range wireless data transmissions using 2.1 GHz bandwidth. Using 60 GHz Band technology, high data rate transfers, such as real-time uncompressed/compressed high-definition (HD) video and audio streams, may be transferred between two devices. Some examples of transfers between two devices under access point (AP) or personal control point (PCP) control include data transfers between a conference room projector and a laptop, between a camcorder and a display, or between a network storage server and a laptop. Other examples abound. Due to this inherent real-time requirement for the targeting applications, 60 GHz standard explicitly defines a Quality of Service (QoS) requirement, called Extended DBand TSPEC (Traffic Specification) for traffic streams to meet high throughput among devices.

The 60 GHz Extended DBand TSPEC describes the timing and traffic requirements of a traffic stream (TS) that exists within a network, such as a Personal Basic Service Set (PBSS) or infrastructure Basic Service Set (IBSS) operating in the 60 GHz Band, which is also referred to as D-Band (or DBand). However, due to the oxygen absorption at 60 GHz and above, the wireless devices operating at the 60 GHz Band need to rely on directional communications, instead of omni-directional propagation of signals used at 2.4 and 5 GHz Bands, to overcome the severe path loss. One enabling technology for directional signal propagation is beamforming, in which DBand devices radiate the propagation energy in a certain direction with a certain beamwidth.

In order to determine and link the directional communication, a typical approach is for a DBand device to initiate a sweep of a plurality of transmit sectors (beam propagation sectors) to cover the omni-directional (or quasi omni-directional) area, after which another DBand device then responds with a sweep of its transmit sectors, as well as informing the initiating device which of the initiator's transmit sector is the best sector for communicating with the responder. After the responder completes its sector sweep, the initiator sends back a feedback signal to indicate which one of the responders sector is best suited for communicating with the initiator. Once the direction is determined for both devices, the directional antennas of the two devices propagate signals in the desired direction to establish the link for communicating between the two devices.

In order to generate the plurality of sweeps and communicate the directional information from a responding device to a beacon initiating device, the 60 GHz specification specifies that after transmission of all of the sweep frames from the responder, the initiating device is to send a feedback signal to provide information relating to the strength of the received signals to determine the desired direction for the link. The feedback signal is generated at the very end of receiving all of the sector sweep information from the responder. However, because not all of the sector sweep frames may be transmitted in one slot of an A-BFT (Association Beamforming Training) period, multiple slots within the A-BFT period may be needed. If other devices are present, collisions may occur that could disrupt the training association being carried out between the responder and the initiator or the feedback signal from the initiator to the responder, so that the desired directional communication linkage by both devices may not occur as rapidly as desired.

Accordingly, there is a need to obtain a much more efficient way to transfer information to establish a communication link between two millimeter-wave devices.

### BRIEF DESCRIPTION OF THE DRAWINGS

FIG. 1 is a block diagram showing a wireless communication system in accordance with one embodiment for practicing the present invention.

FIG. 2 is a schematic block diagram showing an embodiment of a wireless communication device for practicing the present invention.

FIG. 3 is a diagram of a network, such as a Basic Service Set (BSS), in which multiple stations (STAs) are present in the network and communicate with a network control or access point in accordance with one embodiment for practicing the invention.

FIG. 4 is a diagram showing directional signal propagation between the control point and STAs of FIG. 3.

FIG. 5 is an illustration of an example slot usage as practiced in the prior art for an A-BFT period, in which one ScS feedback frame is sent from a beacon initiator after transmission of all ScS frames from a responder.

FIG. 6 is an illustration of an example slot usage as practiced in one embodiment of the invention for an A-BFT period, in which a ScS feedback frame is sent from a beacon initiator for each ScS frame slot sent from a responder.

FIG. 7 is a flow chart showing a method for processing and responding to the received ScS feedback frames in accordance with one embodiment for practicing the invention.

FIG. 8 is a flow chart showing an alternative method for processing and responding to the received ScS feedback frames in accordance with one embodiment for practicing the invention.

FIG. 9 is a flow chart showing still another alternative method for processing and responding to the received ScS feedback frames in accordance with one embodiment for practicing the invention.

### DETAILED DESCRIPTION OF THE INVENTION

The embodiments of the present invention may be practiced in a variety of wireless communication devices that operate in a wireless environment or network. The examples described herein pertain to devices that operate approximately within the 60 GHz Band, which is referred to as DBand. Note that at 60 GHz, the frequency wavelength is in millimeters and, hence, identified as millimeter-wave band. However, the invention need not be limited to the 60 GHz Band. Other millimeter wave bands that use directional signal propagation may also implement the invention. Furthermore, the examples described herein reference specific designations, such as Sector Level Sweep (SLS), Sector Sweep (ScS), Association Beamforming Training (A-BFT), Beacon Transmission Interval (BTI), Feedback frame (FF), etc. However, the invention need not be limited to such specific applications or designations. The invention may be readily adapted to other usages where directional beamforming signals are utilized that require training to determine a direction for establishing a communication link between two wireless devices.

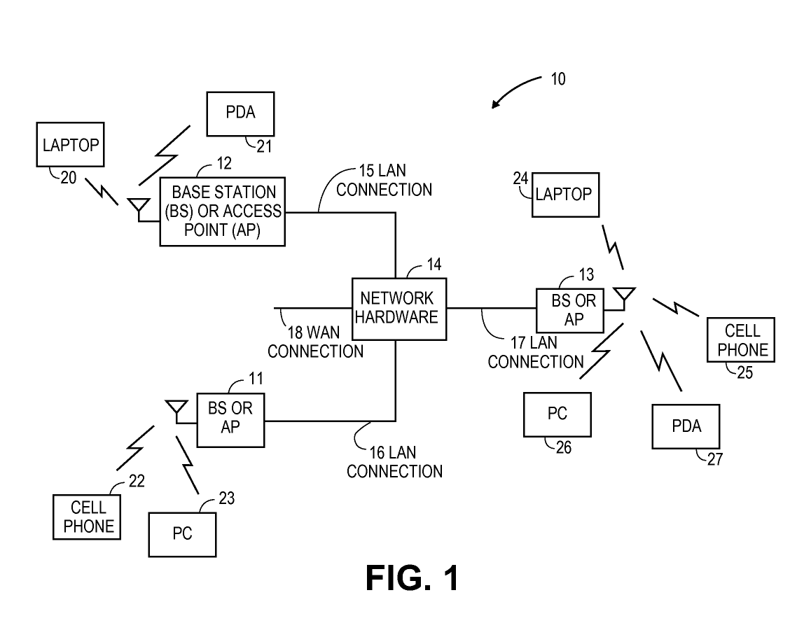

FIG. 1 illustrates one environment for practicing an embodiment of the present invention. FIG. 1 shows a communication system 10 that includes a plurality of base stations (BS), personal control point (PCP) and/or access points (AP) 11-13, a plurality of wireless communication devices 20-27 and a network hardware component 14. The wireless communication devices 20-27 may be laptop computers 20 and 24, personal digital assistants 21 and 27, personal computers 23 and 26, cellular telephones 22 and 25, and/or any other type of device that supports wireless communications.

The base stations or access points 11-13 may be operably coupled to network hardware 14 via respective local area network (LAN) connections 15-17. Network hardware 14, which may be a router, switch, bridge, modem, system controller, etc., may provide a wide area network (WAN) connection 18 for communication system 10. Individual base station or access point 11-13 generally has an associated antenna or antenna array to communicate with the wireless communication devices in its area. Typically, the wireless communication devices register with a particular base station or access point 11-13 to receive services within communication system 10. For direct connections (i.e., point-to-point communications), wireless communication devices may communicate directly via an allocated channel.

Typically, base stations are used for cellular telephone systems (including 3G and 4G systems) and like-type systems, while access points are used for in-home or in-building wireless networks. Regardless of the particular type of communication system, each wireless communication device includes a built-in radio and/or is coupled to a radio. The radio includes a linear amplifier and/or programmable multi-stage amplifier to enhance performance, reduce costs, reduce size, and/or enhance broadband applications. The radio also includes, or is coupled to, an antenna or antennas having a particular antenna coverage pattern for propagating of outbound RF signals and/or reception of inbound RF signals. Antennas may be directional antennas.

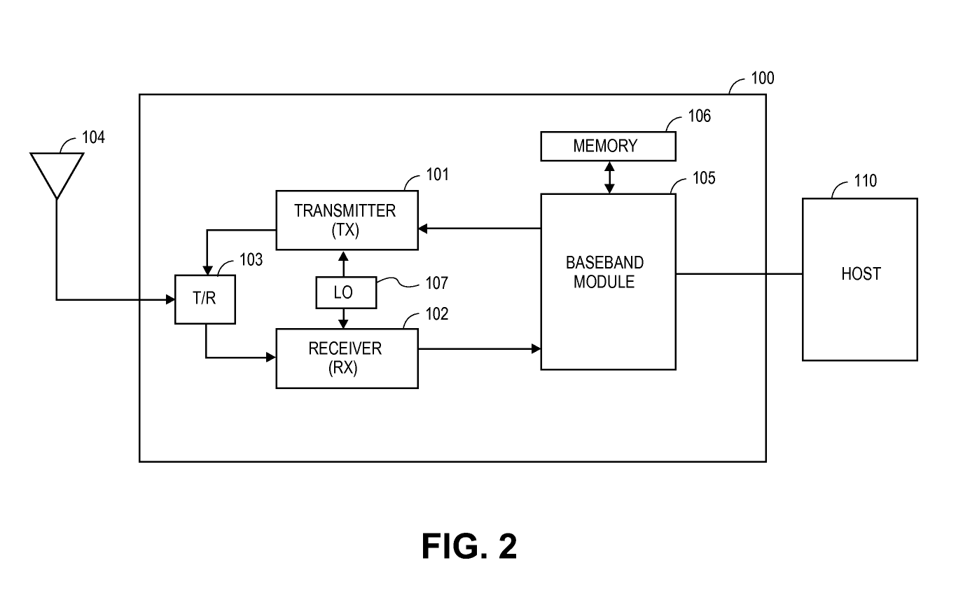

FIG. 2 is a schematic block diagram illustrating part of a wireless communication device 100 that includes a transmitter (TX) 101, receiver (RX) 102, local oscillator (LO) 107 and baseband module 105. Baseband module 105 provides baseband processing operations. In some embodiments, baseband module 105 is or includes a digital-signal-processor (DSP). Baseband module 105 is typically coupled to a host unit, applications processor or other unit(s) that provides operational processing for the device and/or interface with a user.

In FIG. 2, a host unit 110 is shown. For example, in a notebook or laptop computer, host 110 may represent the computing portion of the computer, while device 100 is utilized to provide WiFi and/or Bluetooth components for communicating wirelessly between the computer and an access point and/or between the computer and a Bluetooth device. Similarly, for a handheld audio or video device, host 110 may represent the application portion of the handheld device, while device 100 is utilized to provide WiFi and/or Bluetooth components for communicating wirelessly between the handheld device and an access point and/or between the handheld device and a Bluetooth device. Alternatively, for a mobile telephone, such as a cellular phone, device 100 may represent the radio frequency (RF) and baseband portions of the phone and host 110 may provide the user application/interface portion of the phone. Furthermore, device 100, as well as host 110, may be incorporated in one or more of the wireless communication devices 20-27 shown in FIG. 1.

A memory 106 is shown coupled to baseband module 105, which memory 106 may be utilized to store data, as well as program instructions that operate on baseband module 105. Various types of memory devices may be utilized for memory 106. It is to be noted that memory 106 may be located anywhere within device 100 and, in one instance, it may also be part of baseband module 105.

Transmitter 101 and receiver 102 are coupled to an antenna 104 via transmit/receive (T/R) switch module 103. T/R switch module 103 switches the antenna between the transmitter and receiver depending on the mode of operation. In other embodiments, separate antennas may be used for transmitter 101 and receiver 102, respectively. Furthermore, in other embodiments, multiple antennas or antenna arrays may be utilized with device 100 to provide antenna diversity or multiple input and/or multiple output, such as MIMO, capabilities.

At frequencies in the lower gigahertz range, omni-directional antennas provide adequate coverage for communicating between wireless devices. Thus, at frequencies about 2.4-5 GHz, one or more omni-directional antenna(s) is/are typically available for transmitting and receiving. However, at higher frequencies, directional antennas with beamforming capabilities are utilized to direct the beam to concentrate the transmitted energy, due to the limited range of the signal. In these instances, antenna arrays allow for directing the beam in a particular direction. The 60 GHz DBand as specified by the Wireless gigabit Alliance (WGA or WiGig), specifies that DBand devices utilize directional antennas in order to direct the transmitted spectrum energy.

Outbound data for transmission from host unit 110 are coupled to baseband module 105 and converted to baseband signals and then coupled to transmitter 101. Transmitter 101 converts the baseband signals to outbound radio frequency (RF) signals for transmission from device 100 via antenna 104. Transmitter 101 may utilize one of a variety of up-conversion or modulation techniques to convert the outbound baseband signals to outbound RF signal. Generally, the conversion process is dependent on the particular communication standard or protocol being utilized.

In a similar manner, inbound RF signals are received by antenna 104 and coupled to receiver 102. Receiver 102 then converts the inbound RF signals to inbound baseband signals, which are then coupled to baseband module 105. Receiver 102 may utilize one of a variety of down-conversion or demodulation techniques to convert the inbound RF signals to inbound baseband signals. The inbound baseband signals are processed by baseband module 105 and inbound data is output from baseband module 105 to host unit 110.

LO 107 provides local oscillation signals for use by transmitter 101 for up-conversion and by receiver 102 for down-conversion. In some embodiments, separate LOs may be used for transmitter 101 and receiver 102. Although a variety of LO circuitry may be used, in some embodiments, a PLL is utilized to lock the LO to output a frequency stable LO signal based on a selected channel frequency.

It is to be noted that in one embodiment, baseband module 105, LO 107, transmitter 101 and receiver 102 are integrated on the same integrated circuit (IC) chip. Transmitter 101 and receiver 102 are typically referred to as the RF front-end. In other embodiments, one or more of these components may be on separate IC chips. Similarly, other components shown in FIG. 2 may be incorporated on the same IC chip, along with baseband module 105, LO 107, transmitter 101 and receiver 102. In some embodiments, the antenna 104 may also be incorporated on the same IC chip as well. Furthermore, with the advent of system-on-chip (SOC) integration, host devices, application processors and/or user interfaces, such as host unit 110, may be integrated on the same IC chip along with baseband module 105, transmitter 101 and receiver 102.

Additionally, although one transmitter 101 and one receiver 102 are shown, it is to be noted that other embodiments may utilize multiple transmitter units and receiver units, as well as multiple LOs. For example, diversity communication and/or multiple input and/or multiple output communications, such as multiple-input-multiple-output (MIMO) communication, may utilize multiple transmitters 101 and/or receivers 102 as part of the RF front-end.

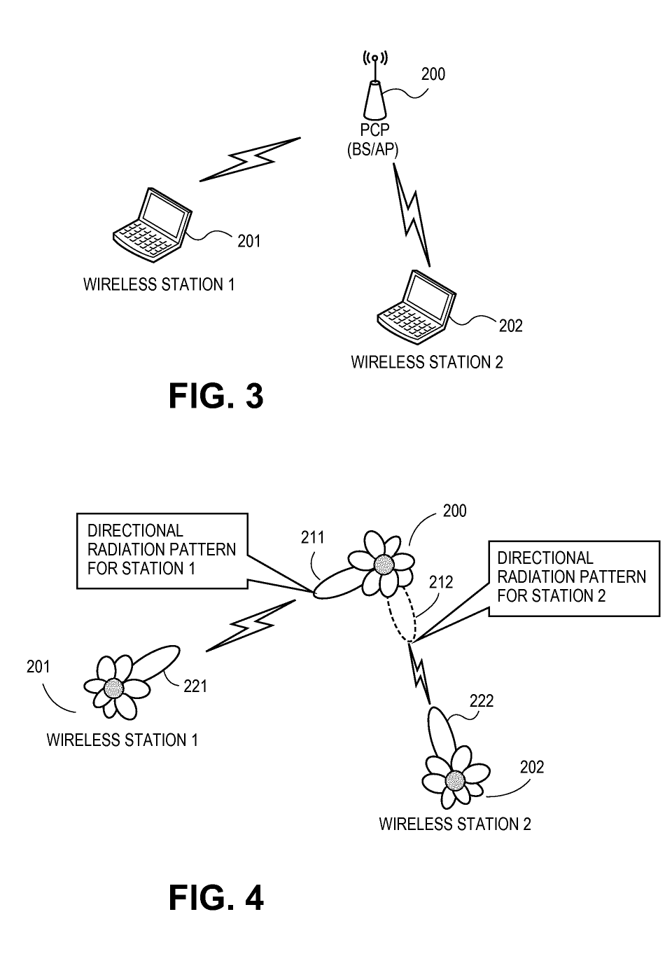

FIG. 3 shows wireless network which may be part of a network, such as a Basic Service Set (BSS). In one embodiment BSS may be a Personal Basic Service Set (PBSS) that forms a personal network. In another embodiment BSS may be an infrastructure Basic Service Set (IBSS) that forms a much larger infrastructure network. Still in other embodiments, the network may operate in other wireless environments.

In the shown embodiment, the example network of FIG. 3 is comprised of a control point 200 and a plurality of stations (STAs) 201, 202 (also noted as “wireless station 1” and “wireless station 2”), which STAs are under control of the control point. It is to be noted that only two STAs are shown, but the network may be comprised of less STAs or more STAs than is shown. The control point may be a Base Station (BS), Access Point (AP), Personal Control Point (PCP) or some other device. Hereinafter in the description, the control point is referred to as PCP 200. Note that PCP 200 may be implemented as part of BS/AP 11-13 of FIG. 1. Likewise, STAs 201, 202 may be equivalent to the wireless devices shown in FIG. 1. STAs 201, 202 may be stationary or mobile devices. Furthermore, in other embodiments, PCP 200 may also be a STA, in which case the various STAs communicate in peer-to-peer communication.

In the shown example, each STA communicates with PCP 200 and may communicate with other STAs through PCP 200. However, one or more STAs may also communicate directly with other STAs through direct peer-to-peer link. As noted above, PCP 200 may be a STA in some instances. To communicate, PCP 200 and STAs 201, 202 employ a particular communication protocol or standard to provide the wireless link among the devices within the network. In one embodiment, the network operates within the 60 GHz DBand as specified by WGA. In other embodiments, the network may operate in other bands or frequency ranges. When operating in the 60 GHz DBand, the devices use directional antennas to direct the transmitted beam. Thus, PCP 200 and STAs 201, 202 each utilize a directional antenna to communicate with each other within the network as shown in FIG. 4.

In a typical 60 GHz communication procedure, beamforming techniques are utilized to radiate energy in a certain direction with certain beamwidth to communicate between two devices. The directed propagation concentrates transmitted energy toward a target device in order to compensate for significant energy loss in the channel between the two communicating devices. Thus, as shown in FIG. 4, PCP 200 transmits a directed beam 211 toward STA 201 and STA 201 transmits a directed beam 221 toward PCP 200 for a directional communication link between PCP 200 and STA 201. Likewise, when PCP 200 and STA 202 want to communicate with each other, PCP 200 transmits a directed beam 212 toward STA 202 and STA 202 transmits a directed beam 222 toward PCP 200 for a directional communication link between the two devices. The directed transmission extends the range of the millimeter-wave communication versus utilizing the same transmitted energy in omni-directional propagation.

However, in order to establish the directional link, the two devices need to identify and learn which direction is optimal (or at least of sufficient signal-to-noise ratio (SNR)) to establish the link. In one technique, such as that specified for 60 GHz DBand communications, an initiating device (initiator) performs a beacon sweep over its transmitting sectors to reach any STA device(s) in the network. A responding device (responder) performs a sector sweep around its location in response to the beacon. Each beam covers a beam sector noted as Sector Level Sweep (SLS) or Sector Sweep (ScS). The sector sweep coverage is typically in all directions, but it need not be omni-directional in beam sector sweeps in some instances. The target or responding device sends its sector sweep information to the initiator to notify the initiator which transmit sector of the initiator is optimal for communicating with the responder. That is, notifying the initiator which transmit beam of the initiator is in the direction toward the responder. The responder's response also contains information about the responder's sector sweep, which allows the initiator to identify which one of the responder's propagation sectors is optimal for communicating with the initiator. The initiator then responds by sending feedback information as to which sector of the responder's is optimal in communicating with the initiator. The feedback information allows the responder to direct its propagation in the direction toward the initiator. With the 60 GHz DBand specification, this communication to establish antenna direction to link both devices is performed during a training period (or sequence) to train both devices to direct their antenna propagation to the other device to establish the communication link.

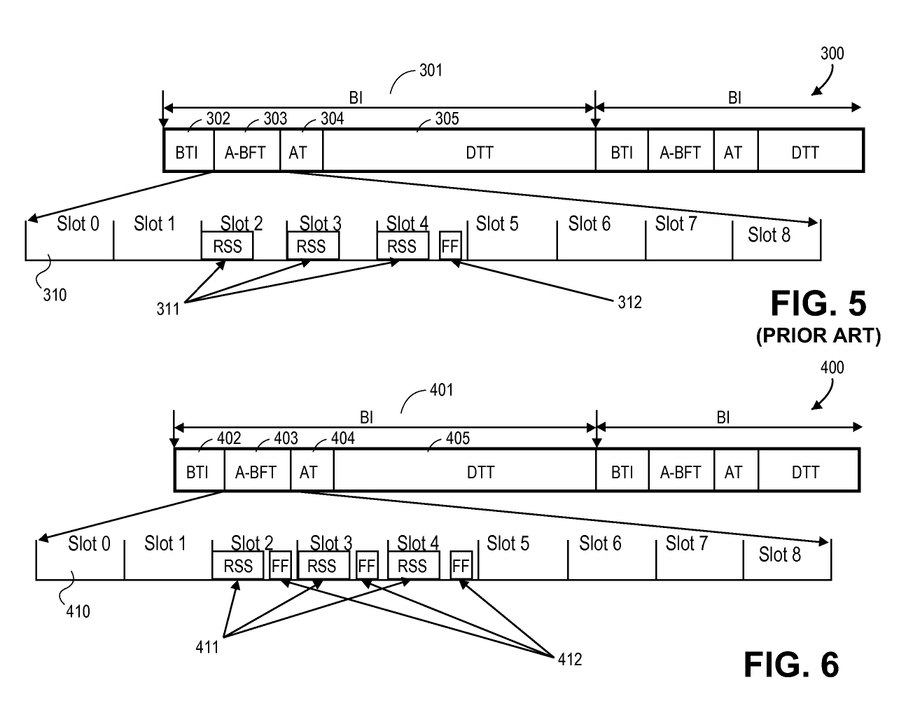

FIG. 5 illustrates a current exemplary beacon signal 300 having a Beacon Interval (BI) 301 under the WGA specification as applied to the 60 GHz DBand standard. BI 301 includes a plurality of access periods (or intervals) as shown in FIG. 5. Beacon Transmission Interval (BTI) 302 is a period that operates similar to traditional beacons. That is, BTI 302 contains one or more Beacon frame(s) that provide information regarding the beacon initiator and is broadcast to the various STAs within the network. With regards to FIG. 3, BTI 302 is generated by PCP 200.

BTI 302 is followed by A-BFT (Association-Beamforming Training Period) 303 and then by Announcement Time (AT) period 304. AT 304 contains one or more Announce frame(s) to provide such functions as allocating service periods. These three periods do not contain payload data. After AT 304, a number of frames may be present to transfer payload data during Data Transfer Time (DTT) period 305. Then, the whole BI 301 repeats again.

The access period noted as A-BFT 303 is dedicated for Responder Sector Sweep (RSS) function. Using the example of FIG. 3, PCP 200 generates BTI 302 by transmitting directional beacons in an omni-directional sweep to search for STA(s). PCP 200 is the initiator in this instance. An STA, such as STA 201 then becomes a responder and transmits RSS to PCP 200. A-BFT period 303 is shown expanded in FIG. 5 and is comprised of multiple ScS slots 310. The number of ScS slots allowed is specified by A-BFT Length in BTI 302 from PCP 300. In the example of FIG. 5, nine ScS slots (#0-#8) are shown. PCP 300 also specifies the maximum sector sweep that may be transmitted in each ScS slot 310. In the current plan for 60 GHz DBand, a maximum of 256 sector sweeps are allowed for each STA. However, this number may change with revisions to the standard. The number of sector sweep frames permitted in each ScS slot 310 is determined by PCP 200 by its FSS value and each STA may not exceed the FSS value per ScS slot 310.

Assume that for the example of FIG. 3, PCP 200 sets a FSS value of 7 and STA 201 performs a sector sweep over 21 sectors. That is, STA 201 has 21 directional beamforming propagation sectors that it sweeps across. STA 201 then sends information about its sector sweeps as RSS 311 in 21 ScS frames (one ScS frame for each sector sweep performed) during A-BFT period 303 to PCP 200. Each ScS frame carries information, such as sector identification (sector ID) and antenna ID for a sector. Since FSS is stipulated as 7 in the example, only 7 ScS frames may be sent per ScS slot 310. Accordingly, 3 slots are needed (3×7=21) by STA 201 for RSS 311 to send all 21 ScS frames.

STA 201 picks the starting ScS slot by random backoff or some other slot contention mechanism. If the number of sectors of STA 201 is greater than FSS, as in this example, STA 201 transmits the next set of ScS frames in subsequent ScS slots given that A-BFT is not completed. In the example, STA 201 selects Slot #2 to commence its transmission. Since 3 ScS slots are needed for 21 sector sweeps, Slots #3 and #4 are also used.

The initiator (PCP 200) can tell the end of RSS 311 by a count down (CDOWN) information embodied in the ScS frames. The CDOWN field is a down-counter indicating the number of remaining ScS frame transmissions to the end of RSS. This field is set to 0 in the last ScS frame transmission. Once successfully receiving one ScS frame, the initiator can obtain CDOWN and know the number of remaining ScS frames to be transmitted by the responder (STA 210) and the exact slot at which RSS is completed. In transmitting the ScS frames, STA 201 informs PCP 200 the best or optimal beacon sector of the initiator's transmission received by STA 201. The ScS frames also inform PCP 200 as to information relating to STA's sector sweeps by conveying sector ID, antenna ID, etc. PCP 200 may identify which signal reception from STA 201 is best or optimal and correlates the best indication to one of the STA's sectors by the ScS frames provided by STA 201. At the completion of RSS 311, PCP 200 sends a feedback frame (FF) to STA 201 to notify STA 201 which of STA's sectors is directed toward PCP 200. Thus, at the end of A-BFT period, PCP 200 knows which PCP transmit sector points toward STA 201. Similarly, STA 201 knows which STA sector points toward PCP 200, so that both devices have directional propagation pointed toward each other, as shown in FIG. 4. A similar technique is used for establishing a communication link between PCP 200 and STA 202.

It is to be noted that transmissions between two devices may be conducted with little concern, if there are only one PCP and one STA in the network. Similarly, if RSS is performed only in one slot, disruptions are minimal. However, when RSS is extended over multiple slots and other devices are within the network that contend for slot time, contentions, collisions and disruptions of the slots may occur frequently, so as to impact performance. Using the above example where three ScS slots are transmitted for STA 201, a contention for the same slot space by STA 202 could cause STA 201 to lose one or more of the slot transmissions. If ScS slot #2 is lost due to contention, STA 201 may need to restart RSS transmission at a later slot. If ScS slot #3 is lost due to contention, then STA 201 may need to restart the RSS transmission as well. The restart depends on if the best sector sweep frame information is lost in the ScS frames being sent to PCP 200. However, if ScS slot #4 is lost due to contention, STA 201 has no choice but to restart the RSS transmission, since FF is not returned from PCP 200. Note that the single FF frame at the end of RSS 311 provides feedback information for all of the ScS frames sent over the three ScS slots by STA 201. It is evident that when ScS frames are sent over many number of slots, probabilities for a retransmission increase significantly and the probability increases as number of devices in the network increases the chances for contention collisions.

FIG. 6 illustrates one embodiment for practicing the invention. In FIG. 6, BI 401 of beacon signal 400 includes BTI 402, A-BFT 403, AT 404 and DTT 405. It is to be noted that BTI 402, A-BFT 403, AT 404 and DTT 405 are equivalent to BTI 302, A-BFT 303, AT 304 and DTT 305, respectively, with one difference. When transmitting ScS slots 410 during A-BFT 403, the initiator (PCP 200) transmits a ScS-Feedback frame to the responder (STA 201) in every ScS slot that there is at least one ScS frame from STA 201 and in which at least one ScS frame is received by the initiator. Thus, in the example of FIG. 6, ScS FF 412 is present after each portion of the RSS transmission 411 in ScS slots #2, #3 and #4.

An advantage of the feedback method of the present invention is that it may reduce the time spent on the link establishment between PCP 200 and the STAs. Since, A-BFT is dedicated for various DBand STAs to perform the sector sweep and any DBand STA is allowed to perform RSS, it is highly likely that more than one DBand STAs choose to transmit ScS frames in the same ScS slot. The direct consequence is that some transmissions collide with each other which cause the ScS frame losses, as described above. There is also a high likelihood a STA will not receive the ScS-Feedback frame 312 due to the collision, and that STA has to perform RSS again in a retry transmission in the subsequent BIs. By placing a ScS FF 412 to provide feedback information for the ScS frames transmitted in that ScS slot, immediate feedback is provided at end of each slot for the respective ScS frames. In some embodiments, the ScS FF 412 for a particular frame may convey information about the ScS frames received in that slot as well as all previous slots in the same BI where RSS occurs.

It is possible that contentions with other responders may cause loss of one or more slots, but some feedback is provided as long as a collision does not occur in a given slot. Those FFs 411 that are fedback to the responder STA may contain the best or optimal sector information, so that the responding STA may be notified as to a sector that is acceptable to use for communicating. This information may be available even if one or more of the ScS frame and/or ScS FF information is lost.

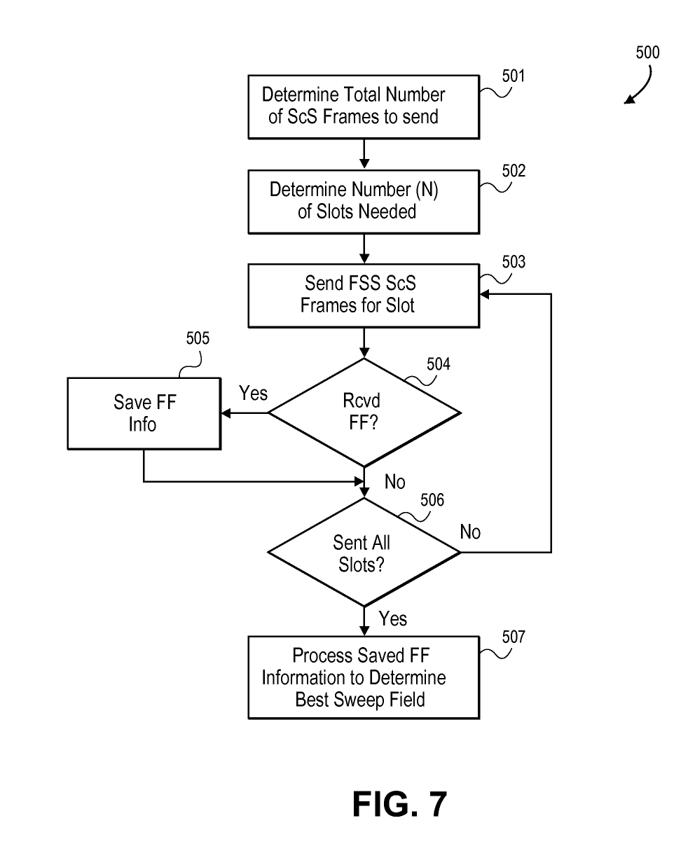

Accordingly, with the feedback frames (ScS FF) being sent in response to ScS frames in each ScS slot, a number of different responses may be applied at the responder. With regard to the PCP 200 and STA 201 example above, FIG. 7 shows one method of operation for STA 201. Process (e.g. method) 500 shows actions of STA 201 (or any responder) in response to receiving a beacon BTI from PCP 200. STA 201 determines the total number of ScS frames it intends to send (block 501) and determines the number N of slots needed (block 502), based on the FSS value received from PCP 200. Then STA 201 selects a slot and sends ScS frames scheduled for that slot as part of its RSS transmission (block 503). STA 201 then determines if a ScS FF from PCP 200 was returned for that slot (block 504). If yes, then the ScS FF information is saved (block 505). Then, a check is made to determine if another slot is to be sent (block 506) and sends the next set of ScS frames in the next ScS slot (block 503), at which point the sequence of blocks as shown in FIG. 7 is repeated, until all ScS frames are sent. At the end when all ScS frames has been sent, STA 201 processes the returned ScS FF information to identify the direction to propagate its signal to establish the directional communication link with PCP 200 (block 507).

With the embodiment of FIG. 7, whenever a ScS FF signal is not received from PCP 200 for a particular ScS slot or slots, STA 201 continues its process to send the ScS frames of the next scheduled slot (blocks 504), until all slots are sent (block 506). In this regard, the sending of ScS slots is similar to the prior art technique of FIG. 5, however, with a significant difference. With the practice of the invention, STA 201 receives feedback information from PCP 200 in each ScS slot that it sends at least one ScS frame. By providing feedback in each slot, STA 201 receives immediate feedback information from PCP 200 regarding ScS sector sweep information sent to PCP 200 in that slot. If STA 201 does not receive a ScS FF signal from PCP 200, STA 201 knows that a collision (or some other disruption) occurred in that slot, which resulted in the ScS frames for that slot not reaching PCP 200 or the feedback signal sent from PCP 200 was disrupted. Assuming that one or more FF signals from PCP 200 did arrive, STA 201 may have enough information to determine which direction to direct its transmission to establish the linkage with PCP 200. Otherwise, STA 201 will retransmit all of the ScS frames in a retry.

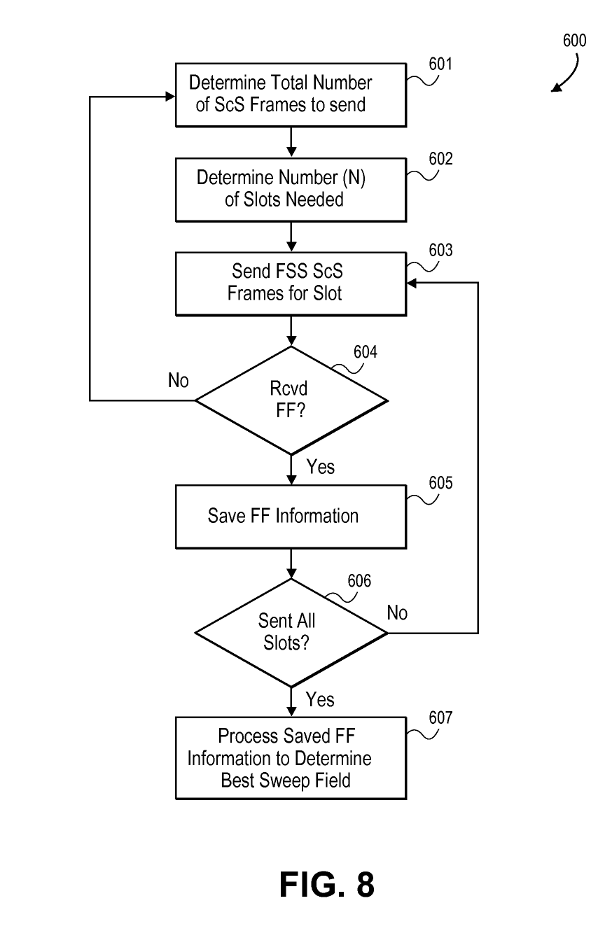

FIG. 8 illustrates an alternative embodiment for the operation of STA 201. In FIG. 8, process (e.g. method) 600 shows actions of STA 201 (or any responder) in response to receiving a beacon BTI from PCP 200. STA 201 determines the total number of ScS frames it intends to send (block 601) and determines the number N of slots needed (block 602), based on the FSS value received from PCP 200. Then, STA 201 selects a slot and sends ScS frames scheduled for that slot as part of its RSS transmission (block 603). STA 201 then determines if a ScS FF from PCP 200 was returned for that slot (block 604). If yes, then the ScS FF information is saved (block 605). Then a check is made to determine if another slot is to be sent (block 606) and sends the next set of ScS frames in the next ScS slot (block 603), at which point the sequence of blocks as shown in FIG. 8 is repeated, until all ScS frames are sent. If a ScS FF signal is not returned in any slot requiring a FF (block 604), this embodiment initiates a retry immediately to resend all of the ScS frames. Note that with the prior art technique of FIG. 5, any loss of ScS frames is not known until the FF signal is fedback at the very end of RSS. When and if all ScS frames are communicated and all FF signals received, STA 201 processes the returned FF information to identify the direction to propagate its signal to establish the directional communication link with PCP 200 (block 607). Note that this technique is advantageous if PCP 200 is to receive all transmitted ScS frames from STA 201 and responding FF signals received by STA 201 to make the directional propagation decision. The interim FF signals in each slot lets STA 1 know if a retry is needed prior to the completion of RSS.

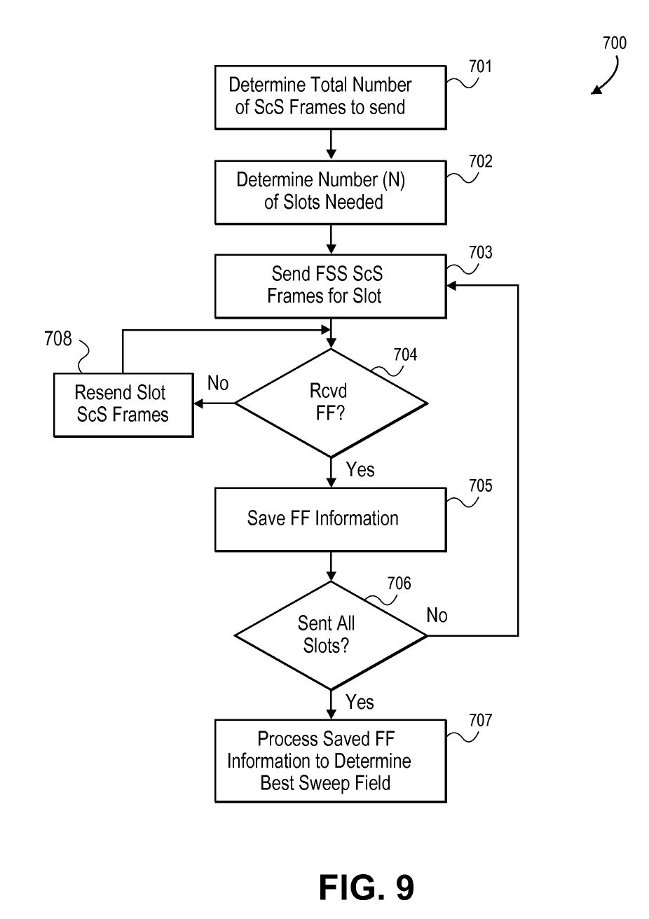

FIG. 9 illustrates still another alternative embodiment for the operation of STA 201. In FIG. 9, process (e.g. method) 700 shows actions of STA 201 (or any responder) in response to receiving a beacon BTI from PCP 200. STA 201 determines the total number of ScS frames it intends to send (block 701) and determines the number N of slots needed (block 702), based on the FSS value received from PCP 200. Then STA 201 selects a slot and sends ScS frames scheduled for that slot as part of its RSS transmission (block 703). STA 201 then determines if a ScS FF from PCP 200 was returned for that slot (block 704). If yes, then the ScS FF information is saved (block 705). Then a check is made to determine if another slot is to be sent (block 706) and sends the next set of ScS frames in the next ScS slot (block 703), at which point the sequence of blocks as shown in FIG. 9 is repeated, until all ScS frames are sent to establish the communication link (block 707). If a ScS FF signal is not returned in any slot requiring a FF (block 704), this embodiment initiates a retry immediately to resend the ScS slot again that did not return a FF signal (block 708). Note that the difference between this technique and that described for FIG. 8, is that in the technique of FIG. 9, the missed FF slot is retransmitted immediately and the remaining slot transmissions are delayed accordingly, but a complete retransmit is most likely not needed, unless not enough slots remain in the particular BI 401.

Accordingly, a number of techniques are available to implement processes that may increase the probability of ascertaining a direction of propagation for both PC 200 and STA 201 (as well as other STAs operating with PCP 200) to establish a directional communication link. The process is applicable with the WGA 60 GHz DBand applications and standards (such as IEEE 802.11 ad protocol), but may be readily adapted to other protocols as well. A variety of devices may implement the invention. FIG. 2 illustrates one device that may be implemented as either AP/BS/PCP or STA to provide the described embodiments. The described processes may be implemented in software, hardware or a combination of both.

Some advantages that may result from the practice of the invention include:

1) a significant increase in the chance for the STA to receive feedback from the PCP;

2) reduction in the time for the STA to establish association with the PCP; and

3) a significant performance increase in a crowded network environment where there are los of contentions among the wireless devices in the network.

Other advantages may be obtained as well.

Thus, fast link establishment for wireless stations operating in millimeter-wave band is described.

As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more corresponding functions and may further include inferred coupling to one or more other items.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. A method comprising:
transmitting at a control point a beacon to initiate a communication link with a station device;
receiving from the station device a plurality of sector sweep frames in a plurality of slots during a training period in response to the beacon; and
transmitting at the control point a feedback signal to the station device in each slot where at least one sector sweep frame is sent from the station device and at least one sector sweep frame is received by the control point, in which a respective feedback frame for a particular slot is a response to the at least one sector sweep frame sent and received in the particular slot, wherein the sector sweep frames and the feedback frames are utilized for the control point and the station device to point directional transmissions to each other to establish a directional communication link.

2. The method of claim 1, further comprising establishing the directional communication link utilizing millimeter-wave transmissions.

3. The method of claim 1, further comprising establishing the directional communication link according to a 60 GHz DBand specification.

4. The method of claim 3, wherein the beacon is transmitted during a Beacon Transmission Interval as specified in the 60 GHz DBand specification.

5. The method of claim 4, wherein the sector sweep frames and feedback frames are transmitted during a training interval as specified in the 60 GHz DBand specification.

6. The method of claim 5, wherein the sector sweep frames and feedback frames are transmitted during Association-Beamforming Training Period as specified in the 60 GHz DBand specification.

7. A method comprising:
receiving at a station device a beacon transmitted from a control point, in which the beacon is to initiate a communication link with a station device;
transmitting at the station device a plurality of sector sweep frames in a plurality of slots during a training period in response to the beacon;
receiving at the station device a feedback signal from the control point in each slot where at least one sector sweep frame is sent from the station device and at least one sector sweep frame is received by the control point, in which a respective feedback frame for a particular slot is a response to the at least one sector sweep frame sent and received in the particular slot, wherein the sector sweep frames and the feedback frames are utilized for the control point and the station device to point directional transmissions to each other to establish a directional communication link.

8. The method of claim 7, further comprising establishing the directional communication link utilizing millimeter-wave transmissions.

9. The method of claim 7, further comprising establishing the directional communication link according to a 60 GHz DBand specification.

10. The method of claim 9, wherein the beacon is transmitted during a Beacon Transmission Interval as specified in the 60 GHz DBand specification.

11. The method of claim 10, wherein the sector sweep frames and feedback frames are transmitted during a training interval as specified in the 60 GHz DBand specification.

12. The method of claim 11, wherein the sector sweep frames and feedback frames are transmitted during Association-Beamforming Training Period as specified in the 60 GHz DBand specification.

13. The method of claim 7, further comprising determining optimal direction of transmission propagation by the station device when only partial feedback frames are received.

14. The method of claim 7, further comprising retrying the transmitting of the plurality of the sector sweep frames by the station device when a feedback frame is not received in a slot that contained transmitted sector sweep frames of the station device.

15. The method of claim 7, further comprising retrying the transmitting of the plurality of the sector sweep frames for a given slot by the station device when a feedback frame for the given slot is not received from the control point.

16. An apparatus comprising:
a control point device to transmit a beacon to initiate a communication link with a station device, receive from the station device a plurality of sector sweep frames in a plurality of slots during a training period in response to the beacon, and transmit a feedback signal to the station device in each slot where at least one sector sweep frame is sent from the station device and at least one sector sweep frame is received by the control point device, in which a respective feedback frame for a particular slot is a response to the at least one sector sweep frame sent and received in the particular slot, wherein the sector sweep frames and the feedback frames are utilized for the control point device and the station device to point directional transmissions to each other to establish a directional communication link; and
a directional antenna coupled to the control point device to provide a directional transmission toward the station device.

17. The apparatus of claim 16, wherein the directional communication link utilizes millimeter-wave transmissions.

18. The apparatus of claim 16, wherein the directional communication link is according to a 60 GHz DBand specification.

19. The apparatus of claim 18, wherein the beacon is transmitted during a Beacon Transmission Interval as specified in the 60 GHz DBand specification.

20. The apparatus of claim 19, wherein the sector sweep frames and feedback frames are transmitted during Association-Beamforming Training Period as specified in the 60 GHz DBand specification.
